(19) United States
(12) Patent Application Publication
(10) Pub. No.: US 2025/0358718 A1
(43) Pub. Date: Nov. 20, 2025

(54) INTELLIGENT CALL CONTINUITY MANAGEMENT AND VOICE RADIO ACCESS TECHNOLOGY SELECTION

(71) Applicant: DISH Wireless L.L.C., Littleton, CO (US)

(72) Inventor: Sougata Saha, Aurora, CO (US)

(21) Appl. No.: 18/668,759

(22) Filed: May 20, 2024

(51) Int. Cl. H04W 48/16; H04W 76/30

(52) U.S. Cl. CPC H04W 48/16; H04W 76/30

(57) ABSTRACT

Various arrangements for switching between Radio Access Technologies (RATs) are present. Measurements can be performed on signals from a first cellular base station by a mobile device that is actively communicating with a second cellular base station. The first cellular base station uses a different RAT than the second cellular base station. The mobile device is compatible with RATs of both the first cellular base station and the second cellular base station. The mobile device can send the measurements for the first cellular base station to the second cellular base station. The second cellular base station can send a release command to the mobile device responsive to the measurements, thus causing the mobile device to connect with the first cellular base station.

### FIELD

The present invention generally relates to communications, and more specifically, to intelligent call continuity management and Radio Access Technology (RAT) selection between two or more networks.

### BACKGROUND

Currently, when a mobile device is in a coverage area where there is roaming partner coverage for both Voice over Long Term Evolution (VOLTE) and Voice over New Radio (VoNR), and the roaming partner coverage overlaps a home network carrier's VONR coverage (i.e., multiple cells overlap), the home network VoNR coverage will be selected or an Evolved Packet System (EPS) fallback will be performed to change radio access from Fifth Generation (5G) to Fourth Generation (4G). However, there is no intelligent selection of the most optimum coverage for the mobile device. Accordingly, an improved and/or alternative approach may be beneficial.

### SUMMARY

Arrangements detailed herein are directed to switching between Radio Access Technologies (RATs). In some embodiments, methods are presented. The method can include performing measurements for a time period on signals from a first cellular base station, by a mobile device that is actively communicating with a second cellular base station. The first cellular base station uses a different RAT than the second cellular base station. The mobile device is compatible with RATs of both the first cellular base station and the second cellular base station. The method can include, after the time period, sending the measurements for the first cellular base station to the second cellular base station. The method can include sending, by the second cellular base station, a release command to the mobile device responsive to the measurements causing the mobile device to scan for the first cellular base station. The method can include connecting, by the mobile device, to the first cellular base station based on receiving the release command.

Embodiments of such a method can include one or more of the following features: The RAT of the first cellular base station can be 5G New Radio (NR) and the RAT of the second cellular base station can be 4G Long Term Evolution (LTE). The method can include calculating, by the second cellular base station, an average value based on the measurements received from the mobile device. The method can include comparing, by the second cellular base station, that the average value with a defined threshold value, wherein sending the release command is based on comparing the average value with the defined threshold value. The release command can include a redirection message that redirects the mobile device to the first cellular base station. The mobile device can connect to the first cellular base station for data services. The measurements can include reference signal received power (RSRP) measurements, signal to interference plus noise ratio (SINR) measurements, or both. The method can include measuring a cell load for the first cellular base station during the time period. The method can include comparing the cell load to a cell load threshold, wherein sending the release command is further based on comparing the cell load to the cell load threshold. A cellular network of the first cellular base station can be prioritized for use by the mobile device over a second cellular network of the second cellular base station. The mobile device can connect to the first cellular base station responsive to determining that a SINR detected by the mobile device for the first cellular base station is greater than a predefined value. The method can include determining, by the mobile device, that a connection with the first cellular base station has been lost or a Quality of Service (QoS) for the mobile device is below a defined threshold. The method can include initiating a fallback operation, by the mobile device, to connect to the second cellular base station. The method can include connecting, by the mobile device, to the second cellular base station in response to initiating the fallback operation. The method can include determining, by the first cellular base station, that the first cellular base station exceeds a number of concurrent users, an amount of traffic exceeds a threshold, or both. The method can include initiating a fallback, by the first cellular base station, to cause the mobile device to connect to the second cellular base station. The method can include connecting to the second cellular base station by the mobile device in response to the fallback initiated by the first cellular base station.

In some embodiments, a system for switching between RATs is presented. The system can include a mobile device, comprising: one or more processors; a first wireless interface; and a second wireless interface. The first wireless interface and the second wireless interface are in communication with the one or more processors. The one or more processors are configured to perform, using the first wireless interface, measurements for a time period on signals from a first cellular base station while the mobile device is actively communicating with a second cellular base station. The first cellular base station uses a different RAT than the second cellular base station. The mobile device is compatible with RATs of both the first cellular base station and the second cellular base station. The mobile device can be configured to, after the time period, send, using the second wireless interface, the measurements for the first cellular base station to the second cellular base station. The mobile device can be configured to receive, from the second cellular base station, a release command responsive to the measurements. The mobile device can be configured to in response to the release command, scan for the first cellular base station. The mobile device can be configured to connect to the first cellular base station based on receiving the release command.

Embodiments of such a system can include one or more of the following features: The RAT of the first cellular base station can be 5G New Radio (NR) and the RAT of the second cellular base station can be 4G Long Term Evolution (LTE). The first wireless interface can use 5G NR RAT and the second wireless interface can use 4G LTE RAT. The second cellular base station can be configured to calculate an average value based on the measurements received from the mobile device and compare the average value with a defined threshold value. The release command can be sent based on comparing the average value with the defined threshold value. The release command can include a redirection message that redirects the mobile device to the first cellular base station. The measurements can include reference signal received power (RSRP) measurements, signal to interference plus noise ratio (SINR) measurements, or both. The first base station can measure a cell load for the first cellular base station during the time period and compare the cell load to a cell load threshold, wherein sending the release command is further based on comparing the cell load to the cell load threshold. The mobile device can determine that a connection to the first cellular base station has been lost or a Quality of Service (QOS) for the mobile device is below a defined threshold, initiate a fallback operation to connect to the second cellular base station, and connect to the second cellular base station in response to initiating the fallback operation. The first cellular base station can be configured to determine that the first cellular base station exceeds a number of concurrent users, an amount of traffic exceeds a threshold, or both, and initiate a fallback operation to cause the mobile device to connect to the second cellular base station. The mobile device can be configured to connect to the second cellular base station in response to the fallback operation initiated by the first cellular base station.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings.

FIG. 1 illustrates a wireless network system that includes both newer generation (e.g., 5G New Radio (NR) and older generation cells (e.g., 4G Long Term Evolution (LTE).

FIG. 2 illustrates an embodiment of a method for performing intelligent call continuity management and voice RAT selection between two or more networks.

FIG. 3 illustrates an embodiment of a method for identifying a specific generation cell.

FIG. 4 illustrates an embodiment of an architectural diagram of a mobile device configured to perform switching between one or more bands based on measurement reports of a cellular base station.

FIG. 5 illustrates an embodiment of a method for switching between networks that use different RATs.

FIG. 6 illustrates an embodiment of a method for calculating the average measured predicted voice performance.

FIG. 7 illustrates an embodiment of a method for connecting to a second cellular network.

FIG. 8 illustrates an embodiment of an architectural diagram of how intelligent call continuity management and voice RAT selection can be performed between two or more networks.

FIG. 9 illustrates an embodiment of a method for switching between RATs.

### DETAILED DESCRIPTION

Some embodiments pertain to intelligent call continuity management and voice RAT selection between two or more networks. As used herein, the “RAT” is the underlying physical wireless connection method for a radio communication network including, but not limited to, 4G Long Term Evolution (LTE), 5G New Radio (NR), Sixth Generation (6G), etc. When a mobile device is connected to an older generation network (e.g., a 4G LTE network), a timer is started by the mobile device and measurements are consistently made by the mobile device of signals from a newer generation cell (e.g., a 5G NR cell), which can also be referred to as a “cellular base station” or “base station.” After the timer expires, the mobile device can send the measurements to a base station of the older generation network, such as an enhanced Node B (eNB) for 4G LTE. In some embodiments, the mobile device may compute averages of the measurements before sending the measurements to the older generation base station.

If an average of the measurements calculated at the mobile device or the older generation network base station exceeds a threshold (e.g., a Reference Signal Received Power (RSRP) of −85 decibels per milliwatt (dBm)) for at least a certain percentage of time, the older generation base station sends a release command to the mobile device with a redirection command to the newer generation cell. This prompts the mobile device to scan for the newer generation cell and connect for data, voice, short message service (SMS), or some combination thereof, to the newer generation cell. In this manner, the newer generation cell can be prioritized, which may have higher uplink and/or downlink bandwidth, enhanced service capabilities, lower latency, ability to utilize slices, etc. as compared to the older generation cell.

Some embodiments also handle the case when the connection to the newer generation cell deteriorates below a threshold or is lost. When this occurs, the mobile device performs a fallback operation and connects to the older generation cell for data, voice, SMS, or some combination thereof. The monitoring process for an available newer generation cell is then repeated. As used herein, a “fallback” refers to the mobile device disconnecting from the newer generation network and connecting to the older generation network. It should be noted that the fallback operation may be from 5G to 4G LTE, from 6G to 5G, from 4G LTE to 3G, or from any newer generation network to any older generation network without deviating from the scope of the embodiments detailed herein.

In the case of 5G, the Non-Standalone (NSA) architecture deployment option is defined in Third Generation Partnership Project (3GPP) Technical Report (TR) 21.915, where 5G networks are aided by existing 4G infrastructure. This differs from standalone 5G, which uses a 5G RAN and a cloud-native 5G core. NSA base stations use Multi-RAT Dual Connectivity (MR-DC) to provide a user plane throughput across both 4G and 5G air-interfaces. Legacy 4G mobile devices can continue to use the eNB as they typically do, whereas newer mobile devices with both 4G and 5G capabilities can take advantage of the MR-DC. This architecture requires an eNB and a Next Generation Node B (gNB) to operate together. The eNB is the base station component for 4G LTE networks, whereas the gNB is the base station component for 5G networks.

The 5G Radio Access Network (RAN) and its NR interface are used in conjunction with the existing LTE and Evolved Packet Core (EPC) (4G RAN and 4G core, respectively). This makes 5G NR technology available without network replacement. In this configuration, only the 4G services are supported, but they enjoy the capacities offered by the 5G NR (e.g., lower latency, wireless uplink and downlink bandwidth, etc.). The NSA is also known as E-UTRA-NR Dual Connectivity (EN-DC) or Multi-RAT Dual Connectivity (MR-DC). In other words, NSA anchors the control signaling of 5G RANs to the 4G EPC.

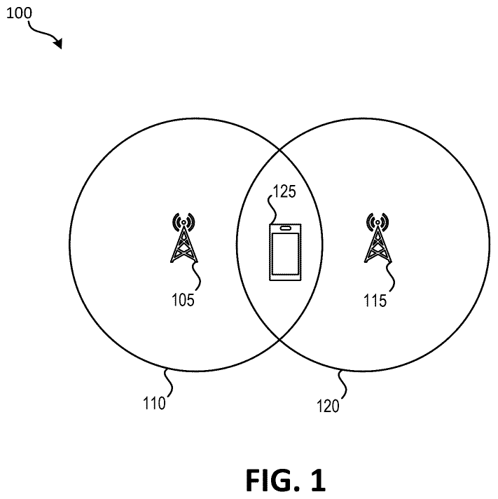

FIG. 1 illustrates a wireless network system 100 that includes both newer generation (e.g., 5G New Radio (NR) and older generation cells (e.g., 4G Long Term Evolution (LTE). Wireless network system 100 includes both an older generation cell 110 (e.g., 4G VOLTE) provided by cellular base station 105 and a newer generation cell 120 (e.g., 5G VONR) provided by cellular base station 115. In some embodiments, cell 110 may be provided by a home network of a mobile device 125 and cell 120 may be provided by a roaming partner, or vice versa. Cellular base stations 105 and 115, such as an eNB and a gNB for 4G LTE and 5G NR, respectively. In certain embodiments, cellular base station 115 may also include an older generation base station (e.g., an eNB). A mobile device 125 is initially in wireless communication with cellular base station 105 (which can also be referred to as “attached” with the base station). Mobile device 125 may be a smart phone, smart watch, tablet computer, computer, modem, or any other suitable user equipment computing system without deviating from the scope of the embodiments detailed herein.

In this example, mobile device 125 supports both the older generation and newer generation RATs and is in coverage range of both cells 110, 120. Also, an NSA architecture is employed whereby mobile device 125 can use both cells. Mobile device 125 activates a timer and performs periodic, or occasional, or continuous measurements (e.g., predictive voice performance).

After the timer on mobile device 125 expires or elapses, a mean, median, or some of combination of the reported measurements is calculated by mobile device 125 and sent to cellular base station 105. Alternatively, the calculation can be performed by cellular base station 105 itself or another component of the cellular network of which the base station is a part. If an average (or other calculation) of the reported measurements is above a threshold for at least a percentage of time, cellular base station 105 sends a release command to mobile device 125 with a redirection message to cellular base station 115. After being released, mobile device 125 scans for the specific newer generation cell (in this case, cell 120) and performs a combined attach for data and voice/SMS with the base station of cellular base station 115. This way, the newer generation network may be prioritized over the older generation network for mobile devices that support both RATs. Such an arrangement may be performed regardless of if the new generation network is a roaming network or a home network for mobile device 125.

It may also be the case after mobile device 125 is attached to cellular base station 115 that the connection is lost or the quality thereof deteriorates (e.g., mobile device 125 moves out of coverage range of cell 120, the base station fails, cellular base station 115 becomes too congested, etc.). When this occurs, mobile device 125 can perform a fallback operation and connect to cellular base station 105. The monitoring process for an available newer generation cell is then repeated by mobile device 125.

Switching between an older generation network and a newer generation network may also be based on predictive voice performance, such as available bandwidth, congestion, Signal-to-Noise Ratio (SNR), etc. For example, if 5G band n71 is congested such that a mobile device is not getting the desired Quality of Service (QOS) via VoNR, the mobile device may be switched to a 4G band and use VOLTE. This may improve the voice quality.

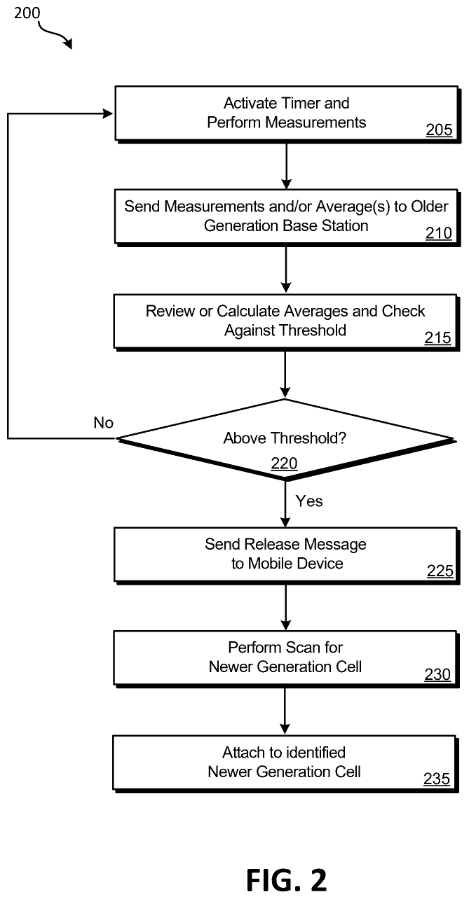

FIG. 2 illustrates an embodiment of method 200 for performing intelligent call continuity management and voice RAT selection between two or more networks. The process begins with a mobile device that supports a newer generation and an older generation RAT, and is attached to an older generation network. The mobile device can activate a timer and periodically (e.g., every second, every five seconds, every ten seconds, etc.), occasionally, or continuously performing measurements of signal from newer generation cell(s) in range (if any) at block 205. The mobile device can send the raw measurements to the base station of the older generation cell or can calculate a value, such as an average, and sends the calculated value after the timer expires at block 210. The measurements may be in the form of a report and may include, but is not limited to, at least one of a usage threshold (or cell load), RSRP, Signal-to-Interference plus Noise Ratio (SINR), SNR, etc.

The older generation base station reviews the measurements or calculated value(s) provided by the mobile device or calculates an average or other value itself and checks the value against a defined threshold at block 215.

For example, the older generation base station may determine whether the RSRP is greater than −85 dBM, the SINR is greater than 4 dB, and/or the cell load on the eNB is greater than a predefined number of users. In some embodiments, a typical cell load may be 60-65 mobile devices. If the average measurements are at or below a threshold at block 220 (e.g., the signal strength was at or below a predetermined amount for at least a percentage of time during the measurements), the timer can be reset and method 200 can return to block 205. However, if the average measurements are above the threshold at 220, the older generation base station sends a release message to the mobile device at 225. For instance, the release command may cause the mobile device to disconnect from the current older generation band and base station, and a redirection command may instruct the mobile device to a newer generation band of another cell, such as the cellular base station from which measurements were made at block 205. The mobile device then scans for the newer generation cell at block 230 prior to performing a combined attach for both data and voice/SMS to the newer generation cell.

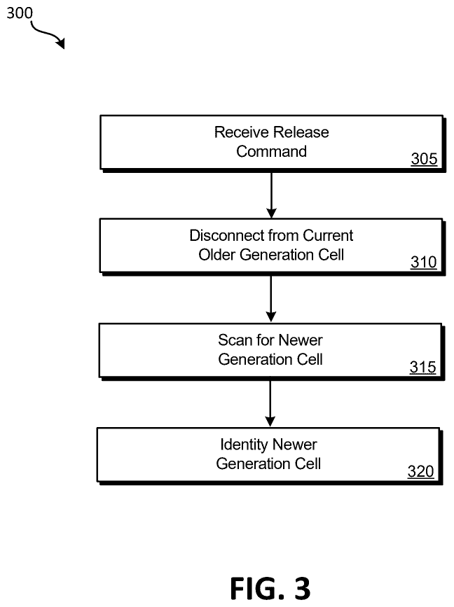

The newer generation cell may be required to meet certain criteria for the mobile device to connect thereto. FIG. 3 illustrates an embodiment of a method 300 for identifying a specific generation cell. In this embodiment, method 300 begins at block 305 with the mobile device receiving a release command from an older generation base station. At block 310, the mobile device, due to the release command, disconnects from the current older generation cell.

At block 315, the mobile device, after receipt of the redirection message for a newer generation cell, searches or scans for the newer generation cell. At block 320, in searching for the newer generation cell, the mobile device identifies another newer generation cell, or in some embodiments, the same NR cell, that meets all or one or more measurement criteria (i.e., predictive voice performance), e.g., RSRP less than 85 dBM, SINR less than 4 dB, and a cell load of less than 40 mobile devices. This differs from current techniques, which perform switching between VoNR and VOLTE using data related performance (and not voice related performance).

Returning back to FIG. 2, at block 235, the mobile device, upon identifying the specific newer generation cell, connects to the specific newer generation cell for both data and voice. In this way, the newer generation RAT may be prioritized over the older generation RAT, or when the connection to the newer generation network is lost or deteriorates, the mobile device may perform a fallback operation to connect to the older generation network while repeating the same method as discussed above to try to identify a newer generation cell, when available. In other embodiments, a connection may only be made for data.

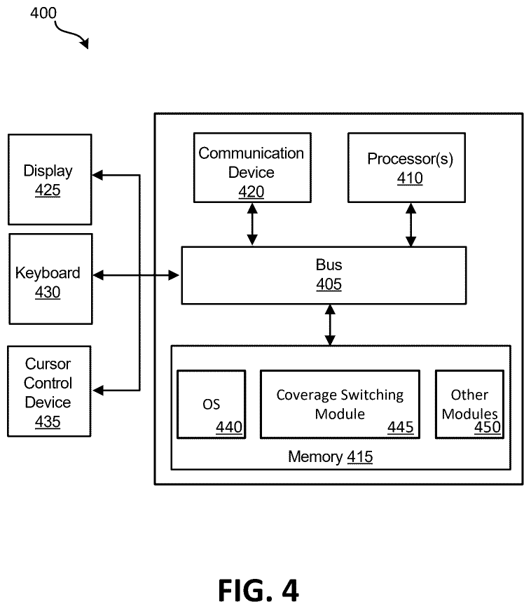

FIG. 4 illustrates an embodiment of an architectural diagram of a mobile device 400 configured to perform switching between one or more bands based on measurement reports of a cellular base station. Mobile device 400 can represent and embodiment of mobile device 125 of FIG. 1. In some embodiments, mobile device 400 can be a smart watch, a tablet, a laptop computer. Similar components as detailed in relation to mobile device 400 can be implemented as part of a base station or node such as an eNB, a gNB, etc., another carrier network server or computing system, or any other suitable computing system without deviating from the scope of the invention in order to perform functions of the cellular network.

Mobile device 400 includes a bus 405 or other communication mechanism for communicating information, and processor(s) 410 coupled to bus 405 for processing information. Processor(s) 410 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 410 may also have multiple processing cores, and at least some of the cores may be configured to perform specific functions. Multi-parallel processing may be used in some embodiments. In certain embodiments, at least one of processor(s) 410 may be a neuromorphic circuit that includes processing elements that mimic biological neurons. In some embodiments, neuromorphic circuits may not require the typical components of a Von Neumann computing architecture.

Mobile device 400 further includes memory 415 for storing information and instructions to be executed by processor(s) 410. Memory 415 can be comprised of any combination of random access memory (RAM), read-only memory (ROM), flash memory, cache, static storage such as a magnetic or optical disk, or any other types of non-transitory computer-readable media or combinations thereof. Non-transitory computer-readable media may be any available tangible media that can be accessed by processor(s) 410 and may include volatile media, non-volatile media, or both. The media may also be removable, non-removable, or both.

Additionally, mobile device 400 includes a communication device 420, such as a transceiver, to provide access to a communications network via a wireless and/or wired connection. Communication device 420 can include multiple cellular interfaces (e.g., 4G and 5G cellular interfaces and circuitry) and one or more antennas. In some embodiments, communication device 420 may be configured to use Frequency Division Multiple Access (FDMA), Single Carrier FDMA (SC-FDMA), Time Division Multiple Access (TDMA), Code Division Multiple Access (CDMA), Orthogonal Frequency Division Multiplexing (OFDM), Orthogonal Frequency Division Multiple Access (OFDMA), Global System for Mobile (GSM) communications, General Packet Radio Service (GPRS), Universal Mobile Telecommunications System (UMTS), cdma2000, Wideband CDMA (W-CDMA), High-Speed Downlink Packet Access (HSDPA), High-Speed Uplink Packet Access (HSUPA), High-Speed Packet Access (HSPA), LTE, LTE Advanced (LTE-A), 802.11x, Wi-Fi, Zigbee, Ultra-WideBand (UWB), 802.16x, 802.15, Home Node-B (HnB), Bluetooth, Radio Frequency Identification (RFID), Infrared Data Association (IrDA), Near-Field Communications (NFC), 5G, NR, any combination thereof, and/or any other currently existing or future-implemented communications standard and/or protocol without deviating from the scope of the invention. In some embodiments, communication device 420 may include one or more antennas that are singular, arrayed, phased, switched, beamforming, beamsteering, a combination thereof, and or any other antenna configuration without deviating from the scope of the invention.

Processor(s) 410 are further coupled via bus 405 to a display 425, such as a plasma display, a Liquid Crystal Display (LCD), a Light Emitting Diode (LED) display, a Field Emission Display (FED), an Organic Light Emitting Diode (OLED) display, a flexible OLED display, a flexible substrate display, a projection display, a 4K display, a high definition display, a Retina® display, an In-Plane Switching (IPS) display, or any other suitable display for displaying information to a user. Display 425 may be configured as a touch (haptic) display, a three-dimensional (3D) touch display, a multi-input touch display, a multi-touch display, etc. using resistive, capacitive, surface-acoustic wave (SAW) capacitive, infrared, optical imaging, dispersive signal technology, acoustic pulse recognition, frustrated total internal reflection, etc. Any suitable display device and haptic I/O may be used without deviating from the scope of the invention.

A keyboard 430 and a cursor control device 435, such as a touchscreen, a touchpad, etc., are further coupled to bus 405 to enable a user to interface with mobile device 400. However, in certain embodiments, a physical keyboard and mouse may not be present, and the user may interact with the device solely through display 425 and/or a touchpad (not shown). Any type and combination of input devices may be used as a matter of design choice. In certain embodiments, no physical input device and/or display is present. For instance, the user may interact with mobile device 400 remotely via another mobile device in communication therewith, or mobile device 400 may operate autonomously.

Memory 415 stores software modules that provide functionality when executed by processor(s) 410. The modules include an operating system 440 for mobile device 400. The modules further include a coverage switching module 445 that is configured to perform all or part of the processes described herein or derivatives thereof. Mobile device 400 may include one or more additional functional modules 450 that include additional functionality.

One skilled in the art will appreciate that a “mobile device” or “portable device” could be embodied as a server, an embedded computing system, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems. The computing system could be part of or otherwise accessible by a local area network (LAN), a mobile communications network, a satellite communications network, the Internet, a public or private cloud, a hybrid cloud, a server farm, any combination thereof, etc. Any localized or distributed architecture may be used without deviating from the scope of the invention.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

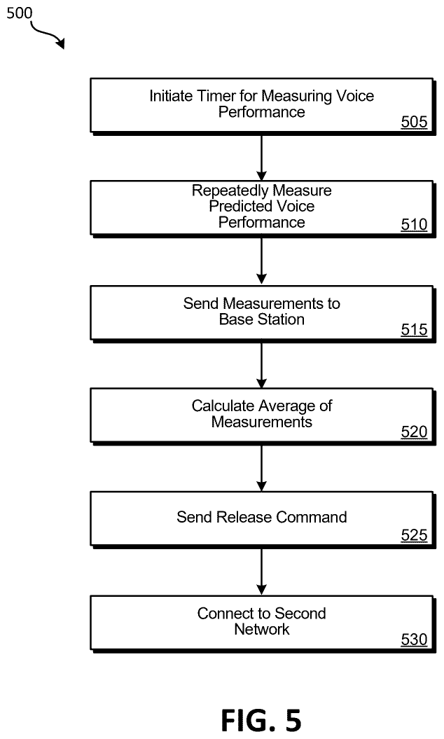

FIG. 5 illustrates an embodiment of a method 500 for switching between networks that use different RATs specifically in the context of voice communications. Method 500 includes initiating, by the mobile device, a timer for measuring a predicted voice performance of the mobile device when the mobile device connects to a first network at block 505. The first network, in some embodiments, is a VoNR or a VOLTE network, and the second network is a VOLTE or a VoNR network. The predicted voice performance metrics may include RSRP, SINR, and a cell load, for example. At block 510, method 500 includes repeatedly measuring, by a mobile device, the predicted voice performance of the mobile device until the timer expires. At block 515, method 500 includes, upon expiration of the timer, sending, by the mobile device, the consistently measured predicted voice performance to a base station of the first network.

At block 520, method 500 includes calculating, by the base station of the first network, an average of the consistently measured predicted voice performance, and at block 525, sending, by the base station, a release command to the mobile device when the calculated average (or other calculated value) predicted voice performance is above a predefined number. In some embodiments, the release command includes a redirection message for the mobile device to connect to a second network. At block 530, method 500 includes connecting, by the mobile device, to the second network for data and voice transmission.

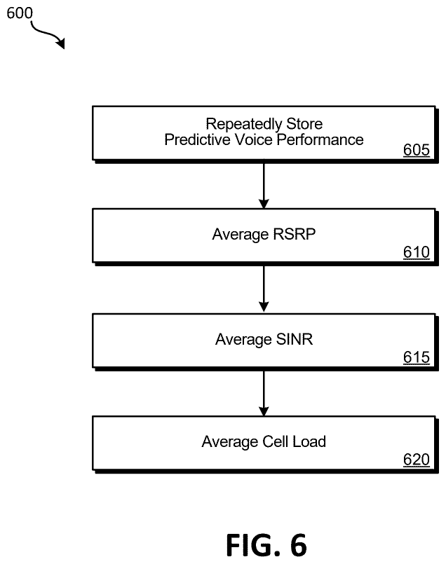

FIG. 6 illustrates an embodiment of a method 600 for calculating the average measured predicted voice performance. Method 600 includes repeatedly storing, by and on the mobile device, the predicted voice performance of the mobile device after each measurement at block 605. At block 610, method 600 includes averaging, by the mobile device, the RSRP from the repeatedly measure predicted voice performance (or some other form of calculation of the RSRP, such as median). At block 615, method 600 includes averaging, by the mobile device, the SINR from the repeatedly measure predicted voice performance (or some other form of calculation). At block 620, method 600 includes averaging, by the mobile device, the cell load from the repeatedly measure predicted voice performance or some other form of calculation.

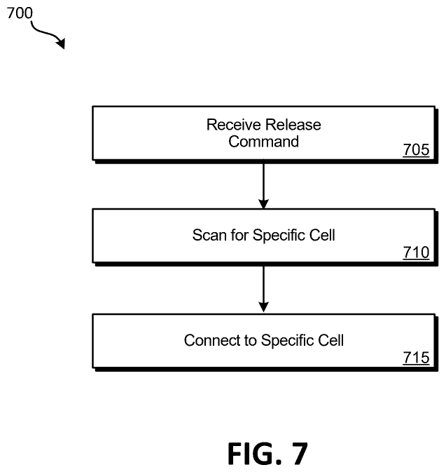

FIG. 7 illustrates an embodiment of a method 700 for connecting to a second cellular network. In some embodiments, method 700 includes receiving, by the mobile device, the release command when a reference signal received power is greater than a predefined decibel milliwatt value, SINR is greater than a predefined decibel level, and/or a cell load is greater than a predefined number of mobile device users on the first network. The release command, in this embodiment, is received from the base station at block 705. At block 710, method 700 includes scanning, by the mobile device, for a specific cell in the second network upon receipt of the release command from the base station. At block 715, method 700 includes connecting, by the mobile device, to the specific cell in the second network for data and voice transmission when the specific cell being scanned includes an RSRP greater than a predefined value, a SINR greater than a predefined value, and/or a cell load less than a predefined number of mobile device users on the first network.

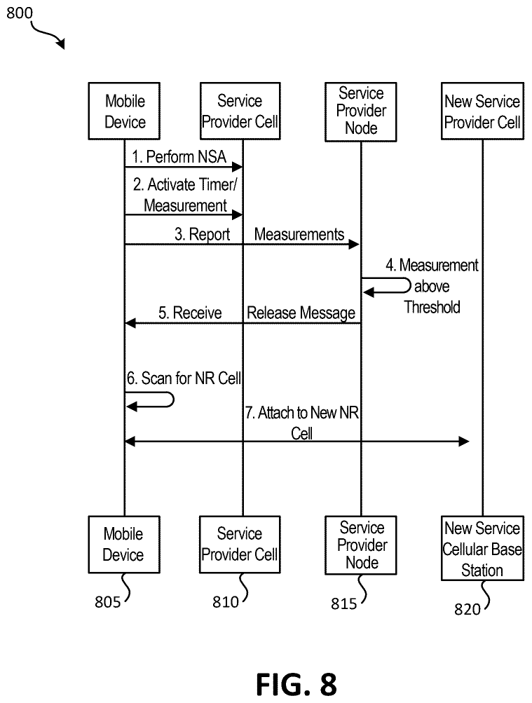

FIG. 8 illustrates an embodiment of an architectural diagram 800 of how intelligent call continuity management and voice RAT selection can be performed between two or more networks. In some embodiments, mobile device 805 is configured to perform NSA upon latching onto a network, such as VoNR or VOLTE. Upon latching onto the network, mobile device 805 activates a timer and performs a predicted voice performance measurement to measure the voice performance of the coverage provided by service provider cell 810. Mobile device 805 continues to perform predicted voice performance measurement for a predefined period of time or until the timer expires.

Mobile device 805 then computes the average (or some other value) of the predicted voice performance and reports the average measurement to service provider node 815 (e.g., a base station or other component that functions as part of the cellular network that includes the base station). Service provider node 815 determines if the reported measurement is above a defined threshold. If so, mobile device 805 receives a release message from service provider node 815, and scans for a new cellular base station to which to connect. Once the new cellular base station is identified, mobile device 805 attaches to the cellular base station (e.g., a 5G NR cell) 820.

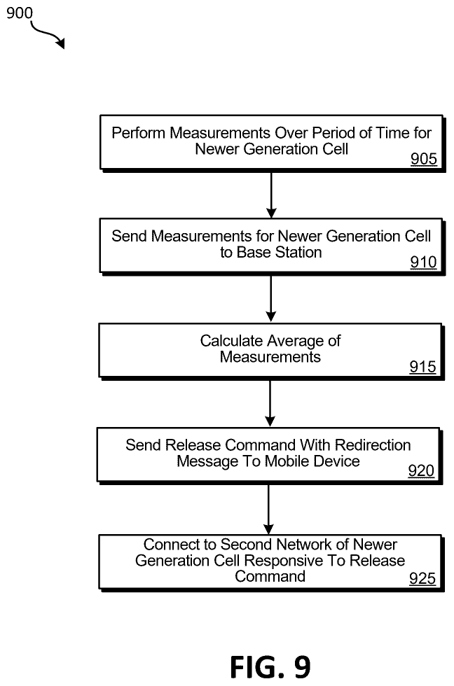

FIG. 9 illustrates an embodiment of a method 900 for switching between RATs. Method 900 begins at block 905 with a VoNR-compatible mobile device performing measurements over a period of time based on signals received from a newer generation cellular base station, such as a 5G NR RAT base station. The mobile device is performing NSA operations and connected to, or actively communicating with, an older generation network (e.g., 4G LTE) for voice, data, and/or SMS services at the time of block 905. At block 910, after expiration of the time period, the mobile device sends the measurements for the newer generation cell to a base station, such as the base station of the newer or older generation base station. At block 915, the base station calculates an average of the measurements. At block 920, the older generation base station sends a release command with a redirection message to the mobile device in response to the calculated average of the measurements being above a threshold, thereby causing the mobile device to scan for the newer generation cellular base station. At block 925, the mobile device connects to a network of the NR cell responsive to receiving the release command.

The process steps performed in FIGS. 2, 3, 5-7, and 9 may be performed by computer program(s), encoding instructions for the processor(s) to perform at least part of the process(es) described in FIGS. 2, 3, 5-7, and 9, in accordance with embodiments of the present invention. The computer program(s) may be embodied on non-transitory computer-readable media. The computer-readable media may be, but are not limited to, a hard disk drive, a flash device, RAM, a tape, and/or any other such medium or combination of media used to store data. The computer program(s) may include encoded instructions for controlling processor(s) of computing system(s) (e.g., processor(s) 410 of mobile device 400 of FIG. 4) to implement all or part of the process steps described in FIGS. 2, 3, 5-7, and 9, which may also be stored on the computer-readable medium.

The computer program(s) can be implemented in hardware, software, or a hybrid implementation. The computer program(s) can be composed of modules that are in operative communication with one another, and which are designed to pass information or instructions to display. The computer program(s) can be configured to operate on a general purpose computer, an ASIC, or any other suitable device.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

What is claimed is:

1. A method for switching between Radio Access Technologies (RATs), comprising:
performing measurements for a time period on signals from a first cellular base station, by a mobile device that is actively communicating with a second cellular base station, wherein:
the first cellular base station uses a different RAT than the second cellular base station;
the mobile device is compatible with RATs of both the first cellular base station and the second cellular base station;
after the time period, sending, by the mobile device, the measurements for the first cellular base station to the second cellular base station;
sending, by the second cellular base station, a release command to the mobile device responsive to the measurements causing the mobile device to scan for the first cellular base station; and
connecting, by the mobile device, to the first cellular base station based on receiving the release command.

2. The method for switching between the RATs of claim 1, wherein the RAT of the first cellular base station is 5G New Radio (NR) and the RAT of the second cellular base station is 4G Long Term Evolution (LTE).

3. The method for switching between the RATs of claim 1, further comprising:
calculating, by the second cellular base station, an average value based on the measurements received from the mobile device.

4. The method for switching between the RATs of claim 3, further comprising:
comparing, by the second cellular base station, that the average value with a defined threshold value, wherein sending the release command is based on comparing the average value with the defined threshold value.

5. The method for switching between the RATs of claim 1, wherein the release command comprises a redirection message that redirects the mobile device to the first cellular base station.

6. The method for switching between the RATs of claim 1, wherein the mobile device connects to the first cellular base station for data services.

7. The method for switching between the RATs of claim 1, wherein the measurements comprise reference signal received power (RSRP) measurements, signal to interference plus noise ratio (SINR) measurements, or both.

8. The method for switching between the RATs of claim 1, further comprising:
measuring a cell load for the first cellular base station during the time period; and
comparing the cell load to a cell load threshold, wherein sending the release command is further based on comparing the cell load to the cell load threshold.

9. The method for switching between the RATs of claim 1, wherein a cellular network of the first cellular base station is prioritized for use by the mobile device over a second cellular network of the second cellular base station.

10. The method for switching between the RATs of claim 1, wherein:
the mobile device connects to the first cellular base station responsive to determining that a SINR detected by the mobile device for the first cellular base station is greater than a predefined value.

11. The method for switching between the RATs of claim 1, further comprising:
determining, by the mobile device, that a connection with the first cellular base station has been lost or a Quality of Service (QOS) for the mobile device is below a defined threshold;
initiating a fallback operation, by the mobile device, to connect to the second cellular base station; and
connecting, by the mobile device, to the second cellular base station in response to initiating the fallback operation.

12. The method for switching between the RATs of claim 1, further comprising:
determining, by the first cellular base station, that the first cellular base station exceeds a number of concurrent users, an amount of traffic exceeds a threshold, or both;
initiating a fallback, by the first cellular base station, to cause the mobile device to connect to the second cellular base station; and
connecting to the second cellular base station by the mobile device in response to the fallback initiated by the first cellular base station.

13. A system for switching between Radio Access Technologies (RATs), comprising:
a mobile device, comprising: one or more processors; a first wireless interface; and a second wireless interface, wherein the first wireless interface and the second wireless interface are in communication with the one or more processors, wherein the one or more processors are configured to:
perform, using the first wireless interface, measurements for a time period on signals from a first cellular base station while the mobile device is actively communicating with a second cellular base station, wherein:
the first cellular base station uses a different RAT than the second cellular base station;
the mobile device is compatible with RATs of both the first cellular base station and the second cellular base station;
after the time period, send, using the second wireless interface, the measurements for the first cellular base station to the second cellular base station;
receive, from the second cellular base station, a release command responsive to the measurements;
in response to the release command, scan for the first cellular base station; and
connect to the first cellular base station based on receiving the release command.

14. The system for switching between the RATs of claim 13, wherein:
the RAT of the first cellular base station is 5G New Radio (NR) and the RAT of the second cellular base station is 4G Long Term Evolution (LTE); and
the first wireless interface uses 5G NR RAT and the second wireless interface uses 4G LTE RAT.

15. The system for switching between the RATs of claim 13, further comprising:
the second cellular base station configured to:
calculate an average value based on the measurements received from the mobile device; and
compare the average value with a defined threshold value, wherein sending the release command is based on comparing the average value with the defined threshold value.

16. The system for switching between the RATs of claim 13, wherein the release command comprises a redirection message that redirects the mobile device to the first cellular base station.

17. The system for switching between the RATs of claim 13, wherein the measurements comprise reference signal received power (RSRP) measurements, signal to interference plus noise ratio (SINR) measurements, or both.

18. The system for switching between the RATs of claim 13, further comprising the first cellular base station, wherein the first cellular base station is configured to:
measure a cell load for the first cellular base station during the time period; and
compare the cell load to a cell load threshold, wherein sending the release command is further based on comparing the cell load to the cell load threshold.

19. The system for switching between the RATs of claim 13, wherein the mobile device is further configured to:
determine that a connection to the first cellular base station has been lost or a Quality of Service (QOS) for the mobile device is below a defined threshold;
initiate a fallback operation to connect to the second cellular base station; and
connect to the second cellular base station in response to initiating the fallback operation.

20. The system for switching between the RATs of claim 13, further comprising the first cellular base station, wherein the first cellular base station is configured to:
determine that the first cellular base station exceeds a number of concurrent users, an amount of traffic exceeds a threshold, or both; and
initiate a fallback operation to cause the mobile device to connect to the second cellular base station, wherein the mobile device is configured to connect to the second cellular base station in response to the fallback operation initiated by the first cellular base station.
